(19) United States
(12) Patent Application Publication
(10) Pub. No.: US 2008/0098648 A1
(43) Pub. Date: May 1, 2008

(54) Insulating jacket

(76) Inventor: Kurt E. Reiger, Oklahoma City, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 11/591,817

(22) Filed: Nov. 1, 2006

(51) Int. Cl. A01G 13/02; A01G 23/04

(52) U.S. Cl. 47/32.7; 47/76

(57) ABSTRACT

A protective apparatus for insulating the root system of a plant includes a side wall made of a material with insulating characteristics. The side wall may be a pair of reflective sheets separated by an air space. The top of the protective apparatus may be a porous material also with insulating characteristics. The protective apparatus will insulate the root system and will prevent the temperature of the root ball and root system from dropping to dangerous levels.

### BACKGROUND OF THE INVENTION

One difficulty faced by plant growers is the protection of plants grown above ground from extreme conditions. Of particular concern for plant growers, and specifically for container plant growers is how to protect plants grown above ground from temperatures cold enough to kill, or cause damage to a plant. When plants are grown outside and the temperatures go below freezing, plants can be damaged. The potential for damage is increased when there is a large fluctuation in temperatures, along with below freezing temperatures. The root ball which may be in or out of a container may reach temperatures that will kill or damage the root system, and thereby kill or damage the plant. Typically, a ground temperature of 32° will not kill a root system, and much colder temperatures are required. The “killing temperature” or killing point of plants will vary depending on the type of plant, but is generally well below the 32° freezing temperature of water.

Although plants will grow in the ground in weather that is cold enough to freeze the ground, when a plant is harvested and held above ground in a container or when a plant is grown in a container above ground, winter freezing and temperatures can kill or severely damage the plant. One primary difference between plants in the ground and plants in containers above the ground in winter is that the root structure in the above-ground container-held plant is exposed to the ambient temperature and conditions whereas the root structure on a plant still in the ground is protected to a great degree from cold temperatures. The ground, even in extreme northern climates will offer insulating protection to the roots of the plant.

There are a number of steps taken by nurseries and plant growers to protect plants from the winter cold. For example, some plants grown outside are often relocated into a greenhouse or other warming structure for the winter. Such steps require additional costs and expense and buildings must be constructed to house the plants. Other common steps taken to protect plants include pushing plant containers together into a large group and then mulching in the group. To do so, a layer of mulch is poured over and between the containers and the plants. When plants are mulched in, great care must be taken to assure that the outer edges of the group of plants are sufficiently mounded with mulch so that all of the plants are sufficiently covered. Another practice includes laying plants down on their sides and placing a frost blanket over the entire plant. In other words, the plant will be laid on its side and if the root ball is in a container, the container itself is covered and the entire plant including all of that portion extending from the root ball is covered. Such an approach is not practical with large plants and trees.

### SUMMARY OF THE INVENTION

A protective apparatus, or jacket, for insulating the root ball, and therefore the root system of a plant has a side wall and a top for covering the root ball. The protective jacket may be used to cover a root ball in a container, or placed directly around a root ball. The side wall is a material with insulating characteristics, and may be, for example, a pair of reflective sheets separated by an air space. The top of the protective jacket may comprise a porous material, so the root ball may be watered therethrough. The top has an opening so the plant stem, or trunk can extend therethrough. The protective jacket will cover the side wall of the container and the open top of the container in which the plant is held, while the trunk and canopy of the plant remain exposed.

A method for insulating the root ball of a plant comprises covering the plant container with a root ball therein with an insulating jacket, and leaving the trunk and canopy exposed. The plant and container with the protective jacket may be placed outside and the protective jacket will simulate the in-ground condition. The protective jacket will limit temperature fluctuations when ambient temperature fluctuates, and will prevent the temperature of the root ball from dropping to dangerous levels, even when the ambient temperature does so.

### DESCRIPTION OF THE DRAWINGS

FIG. 1 is a perspective view of a side wall of the present invention.

FIG. 2 is a top view of the present invention.

FIG. 3 is a perspective view of the invention.

FIG. 4 is a cross section of the invention disposed around a root ball which is not in a container.

FIG. 5 is a cross-section of the protective apparatus of the current invention disposed around a plant container.

### DETAILED DESCRIPTION OF A PREFERRED EMBODIMENT

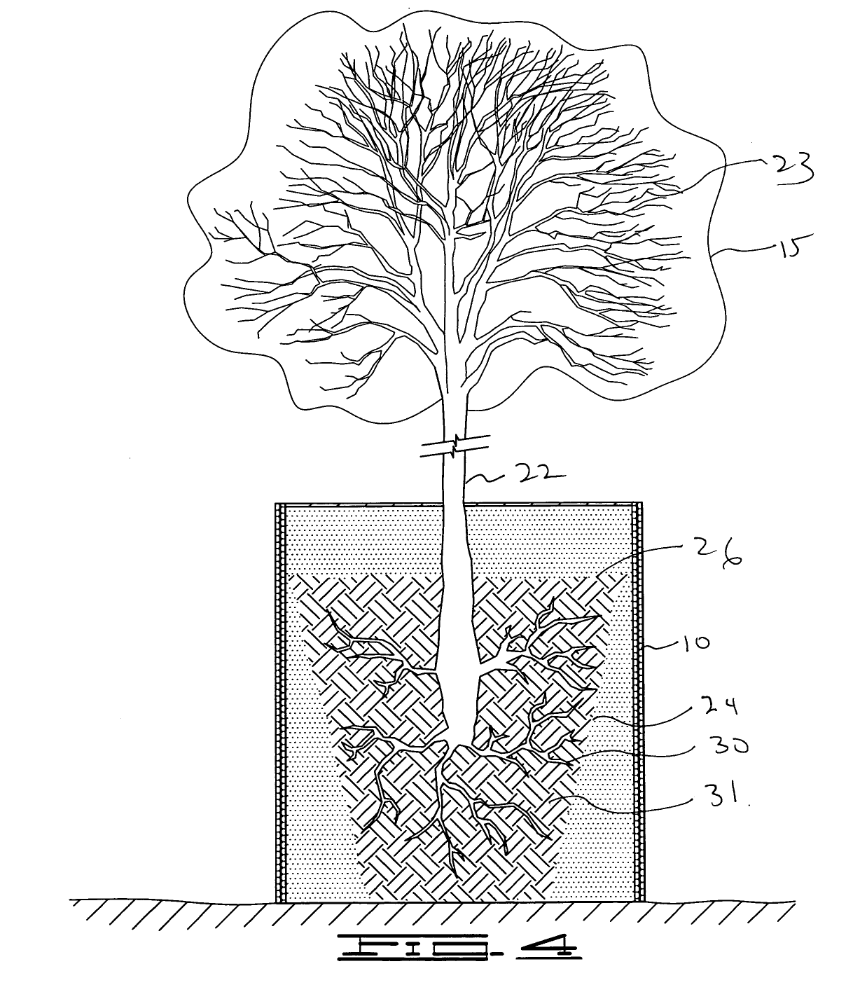

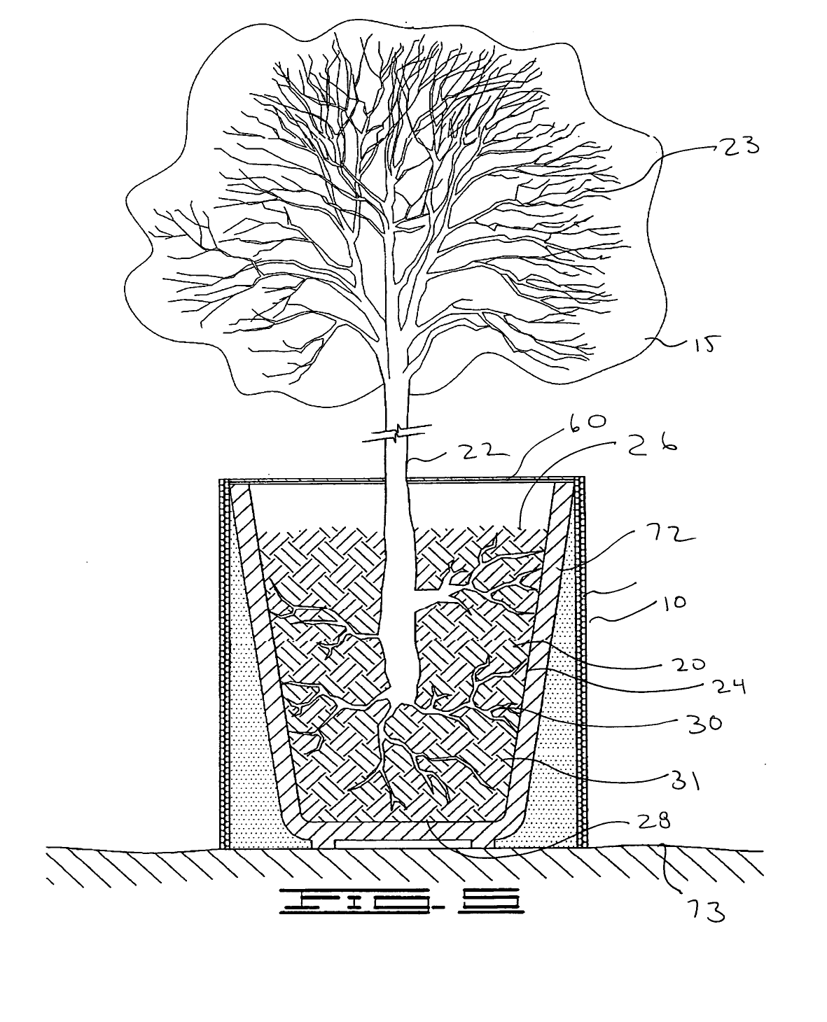

Referring now to FIG. 3, a protective apparatus 10 which may also be referred to as protective jacket 10 is shown in a perspective view. FIG. 5 shows protective jacket 10 positioned to protect a plant 15. Plant 15 has a root ball 20. A trunk or stem portion 22 and a canopy 23 extend above root ball 20. Root ball 20 has outer side 24, a top 26 and a bottom 28. The root ball comprises a root system 30 in a growing media such as soil 31. As is evident from FIGS. 4 and 5, the apparatus or protective jacket 10 of the current invention is designed to cover and protect root ball 20 in the case where the plant is grown in a container or where the root ball is not in a container. In both cases, the trunk or stem 22 and canopy 23 of plant 15 are exposed and when a container is used, protective jacket 10 will cover the container.

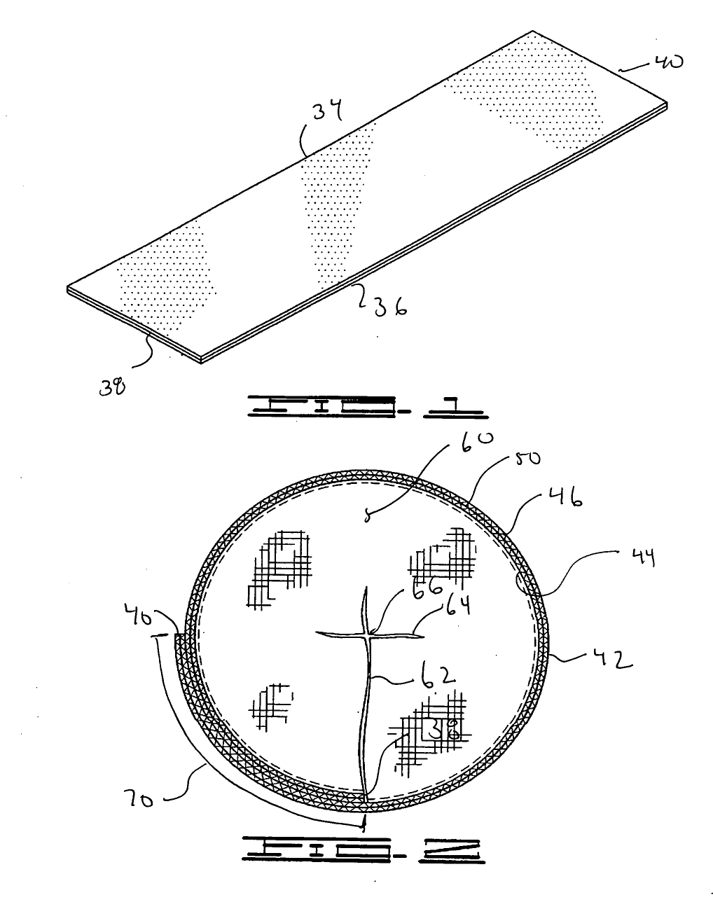

Referring now to FIG. 1, a side or side wall 32 of protective jacket 10 has upper edge 34, lower edge 36, first end 38 and second end 40. Side wall 32 is comprised of an insulating material which may be for example a reflective insulating sheet. The reflective insulating sheet may comprise a first or outer reflective sheet 42 and a second or inner reflective sheet 44 with an air space 46 therebetween. The air space 46 may be created by including a plastic bubble wrap substance. For example each of sheets 42 and 44 may be bonded to a layer of polyethylene and two layers of insulating air pockets may be utilized to resist temperature flow and an additional center layer of polyethylene 50 may provide additional strength. One particular product that may be used for the side wall is Reflectix® Insulation (Double Bubble Foil/Foil).

A jacket top 60 may be attached to the upper edge 34 of side wall 32 to cover the top 26 of root ball 20 when insulating jacket 10 is in place. Top 60 may be comprised of a porous fabric, and is preferably comprised of a porous polyethylene, polypropylene or other woven or non-woven material. By including a porous material, the root ball 20 can be easily watered therethrough. Although in one embodiment the jacket top is of porous material, the top portion can be made from an insulating material that is not porous. Further, while a reflective insulation material is described in one embodiment for the side wall 32, the jacket side wall may be made from other materials with insulating characteristics sufficient to protect against temperatures that are capable of killing unprotected plants, and preventing the root system from reaching the killing temperature of the plant.

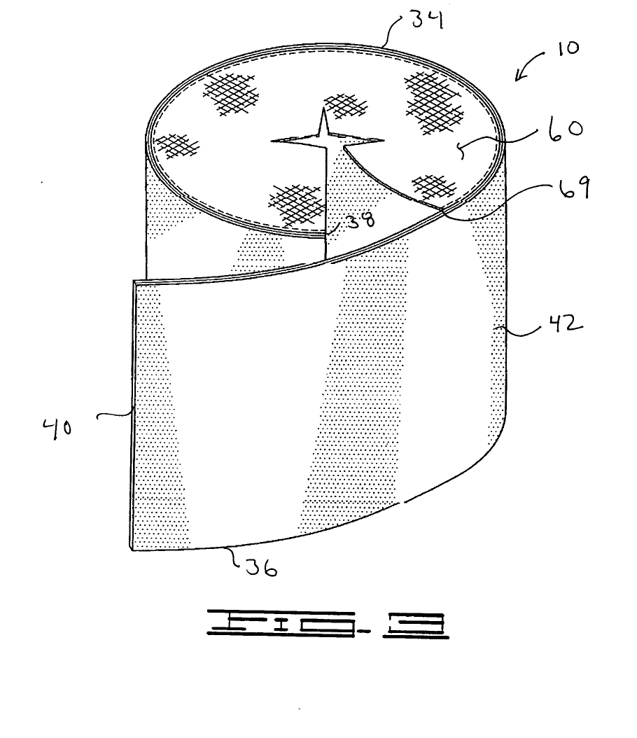

Top 60 has a slit 62 extending over halfway across the diameter of the top as it is seen in FIG. 2. A second slit 64 crosses slit 62 and preferably crosses generally at the center 66 of the top. Top 60 is attached to upper edge 34 by sewing or otherwise. As shown in FIG. 3, top 60 is preferably not attached to the entire periphery at upper edge 34 but rather will begin at first edge 38 and will cover top 26 of root ball 20. The top will be sewn in from edge 38 around the inner periphery 68 of the jacket 10 and will have a terminating end 69 such that top 60 will not be sewn or attached at overlapping portion 70.

In FIG. 5, protective jacket 10 is shown covering a container 72, that is placed on a ground surface 73. The protective jacket may be made of any number of materials having sufficient thickness to insulate the container 72 and root system 30 of a plant 15, and prevent the root system from reaching temperatures that will kill the plant (i.e., the killing temperature). Materials that may be used, for example, include polyethylene, polypropylene and aluminum. The jacket top 60 and jacket side wall 32 may be comprised of any combination of the above, or other materials, in sufficient thickness, such as, for example, at least 5 mils thick to prevent the root system 30 from reaching the killing temperature of the plant. The type of material, and thickness will vary depending upon the environment, and the particular plant. The insulating material should have sufficient insulating capability to prevent the root system in the above-ground container from reaching the killing temperature of the plant in the container. The materials may be layered, and may be configured to have air spaces therebetween, so that the resulting jacket has sufficient insulating characteristics to prevent the root system of a plant in an above-ground container from reaching the killing temperature of the root system of the plant.

Container 72 has a side wall 74, an open top 75 and a bottom 76 and is adapted to hold root ball 20 so that plant 15 may be grown therein. Protective jacket 10 will be sized to fit around container 72 and may be positioned thereabout by folding back overlapping portion 70 and placing side wall 32 around container 72. The trunk or stem portion 22 of the plant, namely that portion extending upwardly from root ball 20, will pass through top 60 at the slits 62 and 64 and preferably at the intersection of slits 62 and 64. Jacket 10 may also be disposed about root ball 20 and container 72 by simply passing plant canopy 23 through the slits until jacket 10 is positioned around container 72.

The lower edge of protective jacket 10 will preferably engage ground surface 73 upon which container 72 is resting. Protective jacket 10 will therefore cover side wall 74 and open top 75 of container 72 so that container 72 and therefore root ball 20, is completely covered by protective jacket 10. Container 72 is therefore insulated from the surrounding environment by protective jacket 10 which will prevent root system 30 from reaching the killing temperature for the plant held in container 72.

The insulating characteristics of insulating jacket 10 are such that when exposed to extreme temperatures, insulating jacket 10 will slow the temperature change of container 72 and root ball 20 to limit the temperature range seen by root ball 20 and therefore by root system 30. As outside temperatures change, the igloo effect of protective jacket 10 will keep the temperatures inside jacket 10 more consistent. It is known that certain temperatures, for example, temperatures that fall well below freezing, and temperatures that fluctuate above and below freezing, can damage, and even kill a root structure and kill the entire plant.

Protective jacket 10 protects and insulates root ball 20 by moderating the temperature thereof. Jacket 10 simulates the conditions seen by plants that are grown in the ground. Even in extreme environments, trees and other plants are not killed by cold temperatures, since the ground acts as an insulator. Jacket 10 is designed to simulate the “in ground” conditions. Jacket 10 has proven effective in insulating a root ball 20.

In January 2006, plants in above ground containers were placed outside in a northern climate. Several plants were in a plastic container only, while others were placed outside in plastic containers with the protective jacket 10 covering the container and the top of the root ball. The temperatures through the month of January ranged from a low of approximately 5° F. to a high of about 55° F. The temperature of a root ball in a plastic container without the protective jacket 10 was measured, and experienced a wide range of temperatures. During the month, the root ball in the unprotected plastic container experienced a low temperature of about 16° F., and a high temperature of approximately 70° F. While the air temperature never reached near 70°, direct sunlight on the plastic container caused an increase in the root ball temperature to above the ambient temperature. On the day the root ball reached 70° F., the ambient air temperature was about 52°. The temperature of the root ball decreased when the air temperature decreased. Thus, the root ball temperature fluctuation pattern was similar to the ambient temperature fluctuation pattern above and below freezing. During times of extended freezing air temperatures, with little sun, the root ball stayed at or well below freezing.

A root ball in a plastic container covered by the protective jacket 10 experienced less extreme temperatures and a much smaller temperature range. The root ball in the jacket covered plastic container had a temperature range from a low of 27° F. to a high of about 43° F. The temperature for a majority of the month hovered at about 30°-32° F., regardless of the ambient air temperature. The protective jacket 10 moderated the temperature of the root ball, and prevented wide temperature fluctuations. No extreme high or low temperatures were experienced by the root ball. The protective jacket 10 insulated the plant root ball and will do so in any environment where plants are grown outside above ground. The temperature in the above example was measured approximately one inch into the soil, and the likelihood is that the temperature deeper into the soil saw less temperature fluctuation, and likely never reached the low temperature of 27°. The temperature seen by the jacket covered plant container was not, for that plant, a temperature low enough to kill the root system.

In the embodiment shown in FIG. 5, the apparatus or protective jacket 10 is shown protecting root ball 20 of plant 15 in container 72. As shown in FIG. 4 protective jacket 10 can be used around a root ball with no container therebetween and will provide the same advantages.

While the top 60 described herein is preferably a porous top 60, an insulating non-porous top may be used as well. Jacket 10 will be comprised of materials with sufficient insulating characteristics to insulate container 72 and root ball 20, and therefore root system 30, to keep root system 30 from experiencing temperatures low enough to kill the root system. Materials that may be used for example include polyethylene, polypropylene and aluminum in sufficient thickness to provide the desired insulating characteristics. The materials may be layered, for example, the side wall 32 and top 60 may comprise layers of materials with air spaces therebetween (for example, aluminum sheets connected to and layered with polyethylene and separated by air spaces). It is believed that a thickness of 5 mils is sufficient to provide the insulating characteristics described for some plants, but in any case the thickness and insulating characteristics are to be sufficient to prevent the root system from reaching its killing temperature.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. An apparatus for protecting a root ball in a container placed on a ground surface: comprising:
a side wall for covering a side wall of the container; and
a top wall for covering an open top of the container, the top wall having an opening for allowing a plant trunk to extend therethrough, the top wall being comprised of a porous material.

2. The apparatus of claim 1, the side wall comprising first and second sheets with an air space therebetween.

3. The apparatus of claim 2, wherein at least one of the first and second sheets is a reflective sheet.

4. The apparatus of claim 3, wherein both of the first and second sheets are reflective sheets.

5. The apparatus of claim 1 wherein the top wall comprises a fabric.

6. The apparatus of claim 5, wherein the wall top comprises a woven polypropylene.

7. The apparatus of claim 1, the side wall and the top comprising flexible materials.

8. The apparatus of claim 1, wherein the side wall comprises a plurality of layers of sheets of material, the sheets of material being selected from the group consisting of polyethylene, polypropylene and aluminum.

9. A method of protecting a plant in an above-ground container comprising:
placing the container on the ground;
covering the container with an insulating material;
providing an opening in the insulating material; and
allowing the plant trunk and canopy to extend through the opening in the insulating material.

10. The method of claim 9 wherein the insulating material comprises:
a side wall; and
a top connected to the side wall, the side wall comprising first and second generally parallel sheets connected to each other and having an air space therebetween.

11. The method of claim 10, wherein the top is comprised of a porous insulating material.

12. The method of claim 11, the top comprising a woven polypropylene material.

13. The method of claim 10, the first and second sheets comprising reflective sheets.

14. A method of protecting plants grown above ground and outside in a plant container comprising:
moderating the temperature of a root ball of the plant; and
exposing the plant trunk and plant canopy to ambient temperatures.

15. The method of claim 14 the moderating step comprising insulating the root ball to prevent the temperature of the root ball from fluctuating with the ambient air temperature.

16. The method of claim 15, the insulating step comprising covering a plant container side wall and an open top of the plant container with an insulating jacket, the insulating jacket having an opening for the plant trunk to extend therethrough so the plant trunk and plant canopy are exposed.

17. The method of claim 16, the insulating jacket comprising a side wall, a top, and an open bottom, the top having the opening for allowing the plant trunk to extend therethrough.

18. A method of protecting plants in a plant container from extreme outdoor temperatures comprising:
wrapping the plant container with a flexible insulating material to cover a side wall of the container and an open top of the container; and
placing the plant container on a ground surface.

19. The method of claim 18, the flexible insulation material comprising a side wall with an upper edge, a lower edge, first and second ends, and a top attached to the upper edge of the side wall wherein the lower edge is supported on the ground surface.

20. The method of claim 19, wherein the top is comprised of a porous fabric.

21. An insulating unit for a plant in a plant container resting on a ground surface comprising an insulating jacket configured to completely cover the container, the jacket having an opening for allowing the plant trunk to extend therethrough.

22. The insulating unit of claim 21, wherein the jacket comprises:
a jacket side wall extending upwardly from the ground surface to at least an open top of the container; and
a jacket top connected to the side wall at an upper end thereof for covering the open top of the container, the opening for allowing the plant trunk to extend therethrough being in the jacket top.

23. The insulating unit of claim 22, wherein the side wall comprises a pair of outer sheets with an air space therebetween.

24. The insulating unit of claim 23, wherein the jacket side wall and jacket top each have a thickness of at least 5 mils.

25. The insulating unit of claim 22, wherein the jacket side wall and top wall have insulating characteristics sufficient to prevent the root system of the plant from reaching a temperature cold enough to kill the plant.

26. The insulating unit of claim 25, wherein the jacket top is attached to the jacket side wall by sewing.
